(19) United States
(12) Patent Application Publication
(10) Pub. No.: US 2008/0283087 A1
(43) Pub. Date: Nov. 20, 2008

(54) DRY CLEANING METHOD OF SEMICONDUCTOR MANUFACTURING APPARATUS HAVING MULTI-LIFTER

(76) Inventor: Ki-Duck Yoon, Osan-si (KR)

Correspondence Address: F. CHAU & ASSOCIATES, LLC, 130 WOODBURY ROAD, WOODBURY, NY, 11797, US

(21) Appl. No.: 12/111,671

(22) Filed: Apr. 29, 2008

(30) Foreign Application Priority Data
May 15, 2007 (KR) 2007-0047026

(51) Int. Cl. B08B 3/00

(52) U.S. Cl. 134/1.1

(57) ABSTRACT

A dry cleaning method for use in a semiconductor manufacturing apparatus having a multi-lifter includes checking whether it is a dry cleaning period, and when it is determined to be a dry cleaning period then checking whether a wafer completed for a process has been returned from an electrostatic chuck to the outside of the semiconductor manufacturing apparatus. The method further includes raising an electrostatic chuck cathode part when the wafer has been returned from the electrostatic chuck to the outside of the semiconductor manufacturing apparatus, and forming plasma after raising the electrostatic chuck cathode part, and performing a dry cleaning process.

### CROSS REFERENCE TO RELATED APPLICATIONS

This application claims priority under 35 U.S.C. § 119 from Korean Patent Application 10-2007-0047026, filed on May 15, 2007, the disclosure of which is hereby incorporated by reference herein in its entirety.

### BACKGROUND

1. Technical Field

The present disclosure relates to a cleaning of semiconductor manufacturing apparatuses, and more particularly, to a dry cleaning method for use in a semiconductor manufacturing apparatus having a multi-lifter, to drive only an electrostatic chuck cathode part, not a lift pin to raise and lower a wafer, in a cleaning process after a semiconductor fabrication process.

2. Description

Generally, in manufacturing semiconductor devices, a wafer undergoes several steps such as, for example, a deposition of material layer, etching for the deposited material layer, cleaning process (e.g. dry cleaning processes), etc. In the above-mentioned semiconductor manufacturing processes, most of the processes include a physical and chemical process such as, for example, chemical vapor deposition (CVD) for performing a material-layer formation and a patterning for the formed material layer.

One of apparatuses for forming a material layer in semiconductor device fabrication processes may be a CVD apparatus. The CVD apparatus decomposes a chemical compound in a gaseous state and then forms a thin film on a semiconductor substrate through a chemical reaction.

Semiconductor devices performing such processes are described in, for example, U.S. Pat. Nos. 5,262,029 and 5,838,529, in which a silicon wafer is positioned in a substrate holder of electrostatic chuck(ESC) during a CVD process within a vacuum chamber. A process gas is supplied into a chamber through several components such as, for example, a gas nozzle, gas ring, gas diffusion plate etc. Other apparatuses for processing a semiconductor substrate may be, for example, a transfer mechanism, gas supply system, liner, lift mechanism, robot arm, fastener, loadlock, door mechanism, etc.

In various semiconductor manufacturing apparatuses, a wafer process is performed in a processor chamber keeping optimum process conditions. Before loading the wafer to such process chamber, a loadlock chamber is used to provide the wafer with an environment which is substantially the same as the process chamber.

The loadlock chamber may be classified as a loading loadlock chamber and an unloading loadlock chamber according to the sequence of processes. The loading loadlock chamber is for applying wafers into a process chamber and the unloading loadlock chamber is for discharging and transferring wafers that were completed for all processes within the process chamber, to either a standby state or subsequent process chamber.

In the respective loading loadlock chamber and unloading loadlock chamber, various types of wafer transfer equipment such as, for example, a robot arm to transfer respective wafers are provided. A chuck that is provided in the processor chamber and fixes a wafer, is provided with a lift pin assembly which ascends/descends therein.

A conventional semiconductor manufacturing apparatus having such wafer chuck is described as follows, referring to FIG. 1 according to a conventional art.

A process chamber 100 is constructed of an upper chamber 110 and a lower chamber 120. In a sidewall of main body 111 of the upper chamber 110, gas nozzle apertures 113 for a uniform diffusion of process gas are formed with a constant interval. A cover body 115 of the upper chamber 110 has a dome shape and is composed of ceramic material.

A cathode driving unit 125 for a vertical ascent/descent of electrostatic chuck cathode part 123 is installed vertically piercing through a bottom face center of main body 121 of the lower chamber 120. The electrostatic chuck cathode part 123 is adapted to fix a wafer(not shown) to be etched processed. The electrostatic chuck cathode part 123 seals up a bottom face opening part 117 of the main body 111 from an uppermost position thereof. In a sidewall of main body 121 of the lower chamber 120 and the interior of the electrostatic chuck cathode part 123, a passage 127 having a flow of cooling medium such as, for example, helium (He) is formed. Wafer lift pins 128 are individually installed vertically piercing evenly through predetermined portions of the electrostatic chuck cathode part 123, so as to vertically elevate the wafer(not shown). In addition, a lift pin driving part 129 to vertically raise and lower the lift pin 128 is adapted in an inner bottom part of main body of the lower chamber 120. The internal pressure of the upper chamber 110 is controlled by a closed loop pressure control system (not shown) that has a throttle valve and that is adapted to seal up the opening part 117 of the main body 111.

Though not shown in the drawings just for description convenience, a plasma generating apparatus for a plasma generation is provided on the outer side of the etching chamber.

In an etching chamber having such conventional configuration, as shown in FIG. 1, the electrostatic chuck cathode part 123 keeps sealing up the bottom face opening part 117 of main body 111 of the chamber 110 at the uppermost position thereof, while an etching is performed in the internal space of the chamber 110. A wafer (not shown) is fixed onto an upper surface of the electrostatic chuck cathode part 123.

When the etching process on the wafer is completed, the cathode driving part 125 descends vertically, and then the electrostatic chuck cathode part 123 also descends. At this time, the electrostatic chuck cathode part 123 descends to a level of wafer apply/discharge opening between the lower chamber 120 and a transfer chamber (not shown) so as to transfer the wafer.

When the descent of the electrostatic chuck cathode part 123 is completed, the lift pin driving part 129 vertically ascends, and a lift pin contact part 129a of the lift pin driving part 129 raises the lift pin 128. Thus, the wafer is spaced with a constant distance from an upper surface of the electrostatic chuck cathode part 123 by raising the lift pin 128.

Subsequently, a door of the wafer apply/discharge opening is opened and a wafer transfer robot of the transfer chamber transfers the wafer to the transfer chamber through the wafer apply/discharge opening, and then the wafer is finally transferred to a wafer cassette (not shown).

Then, the robot puts another wafer for an etching process on the lift pin 128 of the electrostatic chuck cathode part 123, through the wafer apply/discharge opening from the wafer cassette, and then goes back to the original position. Next after that, the door of wafer apply/discharge opening is closed. Subsequently, the lift pin contact part 129a descends by a drive operation of the lift pin driving part 129, and the lift pin 128 also descends. Thus, the wafer is fixed to an upper surface of the electrostatic chuck cathode part 123.

Then, the cathode driving part 125 ascends vertically to an uppermost position as available, thereby sealing up the bottom face opening part 117 of main body 111 of the upper chamber 110. In this state, an actual etching process is performed.

In the conventional semiconductor manufacturing apparatus of FIG. 1, the processes are executed, and a cleaning process is performed with a given period. The cleaning process is performed as illustrated in a flowchart of FIG. 2. With reference to FIG. 2, in step 101 it is checked whether or not it is a cleaning period, and when it is a cleaning period, step 102 is performed. In step 102 it is checked whether a wafer completed for the process has been returned from the electrostatic chuck cathode part 123 to the outside, and when returned, it goes to step 103. In step 103, the lift pin ascends to drive the lift pin driving part 129 so as to elevate the wafer. In step 104, a cathode driving part 125 is driven so that the electrostatic chuck cathode part 123 ascends, and then step 105 is performed. In step 105, a cleaning gas is supplied to the upper chamber 110, thereby forming plasma and performing a cleaning process. Next, step 106 is executed. It is checked in step 106 whether a dry cleaning process is completed, and when the dry cleaning process is completed, step 107 is performed. In step 107, the cathode driving part 125 is driven so that the electrostatic chuck cathode part 123 descends, and then step 108 is performed. In step 108, the lift pin driving part 129 is driven, lowering the lift pin 128. Then, in step 109 the electrostatic chuck cathode is placed into an idle state.

In such conventional semiconductor manufacturing apparatus, when it is a dry cleaning period, a lift pin for a dry cleaning process ascends, and then when the dry cleaning process is completed, the lift pin descends. Consequently, the above-mentioned conventional apparatus and methods require unnecessary operations which turn result in a decrease in productivity.

### SUMMARY OF THE INVENTION

Exemplary embodiments of the invention provide a dry cleaning method for use in a semiconductor manufacturing apparatus having a multi-cylinder, which is capable of increasing productivity by skipping a process for an ascending/descending of lift pin in the dry cleaning of semiconductor manufacturing apparatus.

In accordance with an exemplary embodiment of the invention, a dry cleaning method for use in a semiconductor manufacturing apparatus having a multi-lifter is provided. The method includes checking whether it is a dry cleaning period, and when it is determined to be a dry cleaning period then checking whether a wafer completed for a process has been returned from an electrostatic chuck to the outside of the semiconductor manufacturing apparatus. The method further includes raising an electrostatic chuck cathode part when the wafer has been returned from the electrostatic chuck to the outside of the semiconductor manufacturing apparatus, and forming plasma after raising the electrostatic chuck cathode part, and performing a dry cleaning process.

The method may further comprise lowering the electrostatic chuck cathode part when the dry cleaning process is completed.

In accordance with another exemplary embodiment of the invention, a dry cleaning method for use in a semiconductor manufacturing apparatus having a multi-lifter is provided. The method includes checking whether it is a dry cleaning period, and when it is determined to be a dry cleaning period then checking whether a wafer completed for a process has been returned from an electrostatic chuck to the outside of the semiconductor manufacturing apparatus. The method further includes raising the electrostatic chuck cathode part without raising the lift pin of the apparatus for raising and lowering a wafer when the wafer has been returned from the electrostatic chuck to the outside of the semiconductor manufacturing apparatus, and forming plasma after raising the electrostatic chuck cathode part, and performing a dry cleaning process.

The method may further comprise lowering the electrostatic chuck cathode part without lowering the lift pin of the apparatus for raising and lowering a wafer when the dry cleaning process is completed.

### BRIEF DESCRIPTION OF THE DRAWINGS

Exemplary embodiments of the present invention can be understood in more detail from the following description taken in conjunction with the accompanying drawings in which a:

FIG. 1 illustrates a structure of semiconductor manufacturing apparatus according to the conventional art;

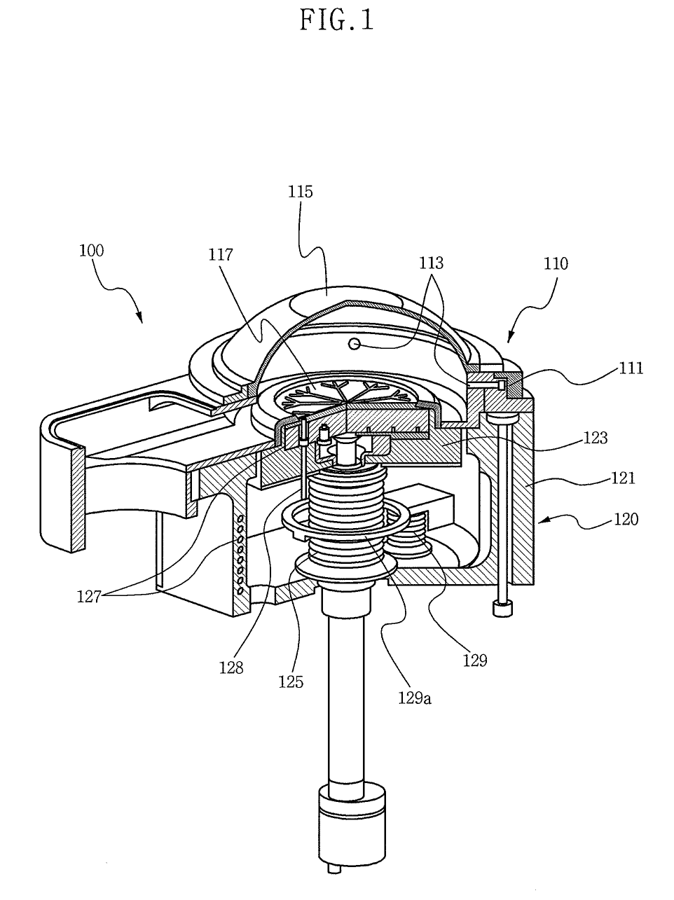

FIG. 2 is a flowchart providing a conventional plasma cleaning process;

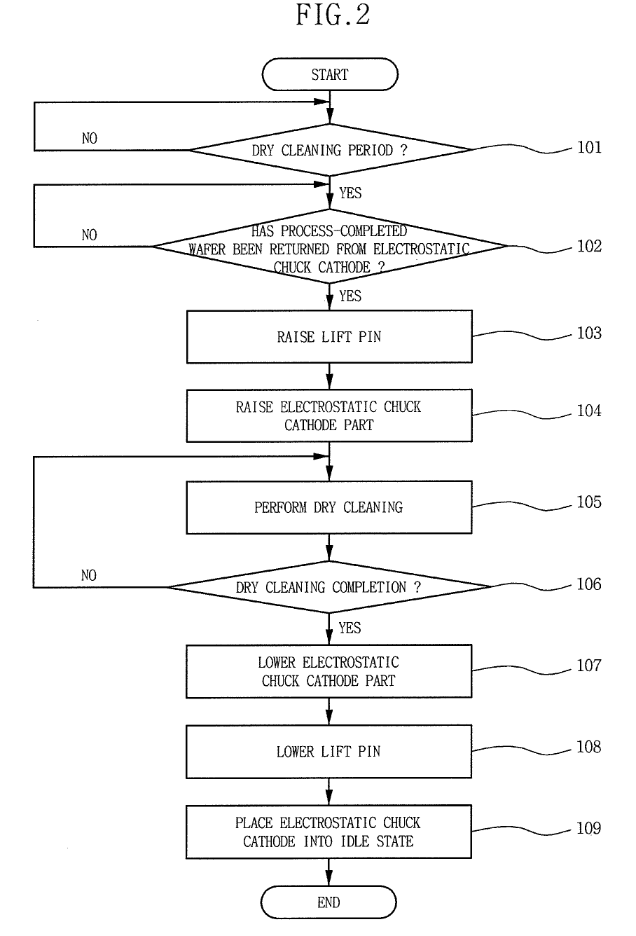

FIG. 3 illustrates a structure of a semiconductor manufacturing apparatus according to an exemplary embodiment of the invention; and

FIG. 4 is a flowchart providing a plasma cleaning process according to an exemplary embodiment of the invention.

### DETAILED DESCRIPTION OF THE EXEMPLARY EMBODIMENTS OF THE INVENTION

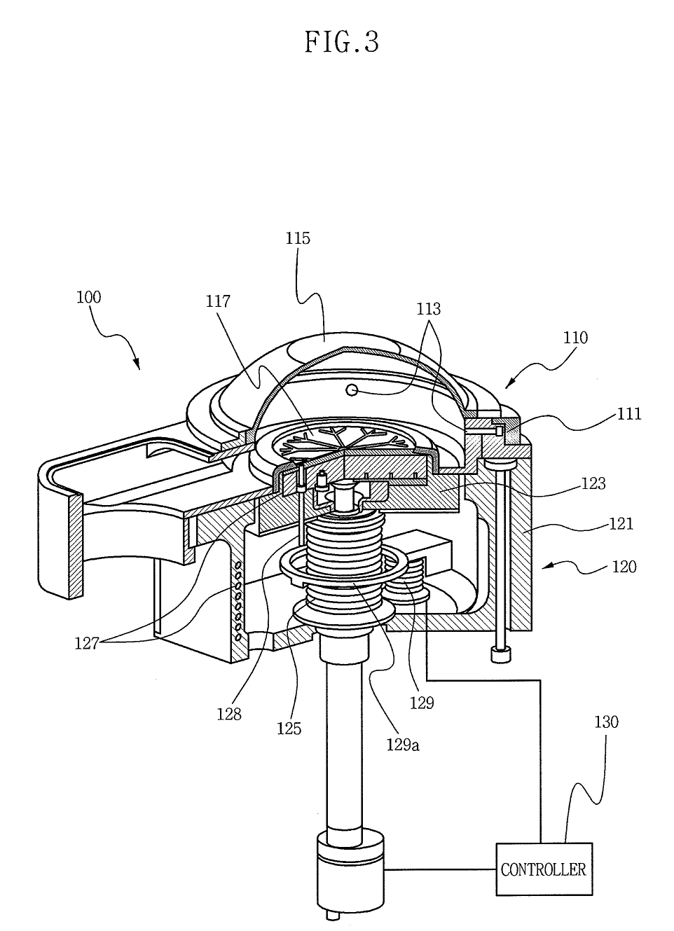

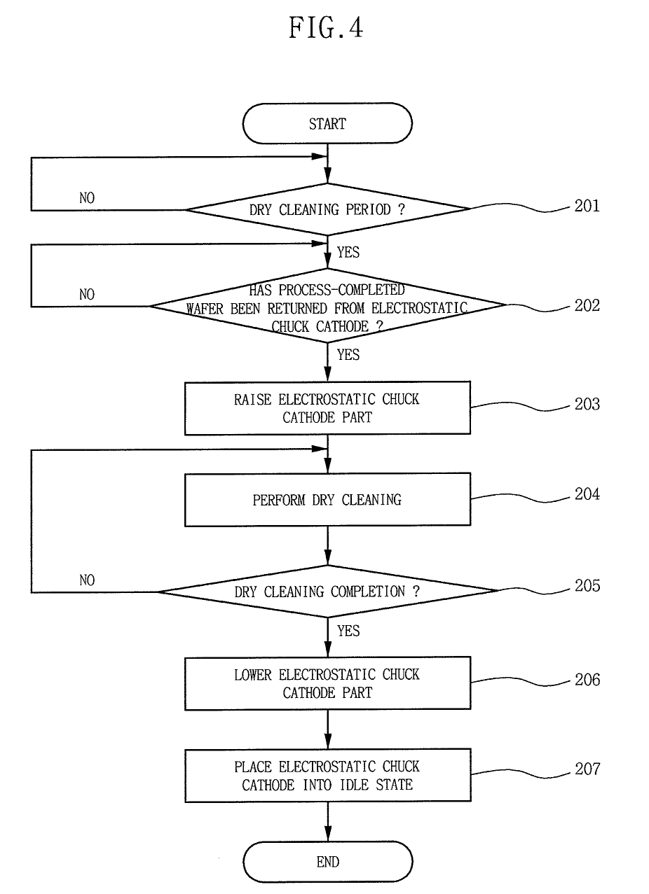

Exemplary embodiments of the present invention now will be described more fully hereinafter with reference to FIGS. 3 and 4. The exemplary embodiments of the invention may, however, be embodied in many different forms and should not be construed as limited to the embodiments set forth herein.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For purposes of clarity, a detailed description of known functions and systems has been omitted.

FIG. 3 illustrates a structure of semiconductor manufacturing apparatus according to an exemplary embodiment of the invention.

Referring to FIG. 3, a process chamber 100 is constructed of an upper chamber 110 and a lower chamber 120. In a sidewall of main body 111 of the upper chamber 110, gas nozzle apertures 113 for providing an even spraying of a process gas are formed with a constant interval. A cover body 115 of the upper chamber 110 has a dome shape and is composed of ceramic material.

A cathode driving unit 125 for a vertical ascent/descent of electrostatic chuck cathode part 123 is installed vertically piercing through a bottom face center of main body 121 of the lower chamber 120. The electrostatic chuck cathode part 123 is adapted to fix a wafer to be etched processed. The electrostatic chuck cathode part 123 seals up a bottom face opening part 117 of the main body 111 from an uppermost position thereof. In a sidewall of main body 121 of the lower chamber 120 and the interior of the electrostatic chuck cathode part 123, a passage 127 having a flow of cooling medium such as, for example, helium (He) is formed. Wafer lift pins 128 are individually installed vertically piercing evenly through predetermined portions of the electrostatic chuck cathode part 123, so as to vertically elevate the wafer. In addition, a lift pin driving part 129 to vertically raise and lower the lift pin 128 is provided in an inner bottom part of main body of the lower chamber 120. The internal pressure of the upper chamber 110 is controlled by a closed loop pressure control system that has a throttle valve and that is adapted to seal up the opening part 117 of the main body 111.

A controller 130 performs a control to raise only the electrostatic chuck cathode part 123, without raising a lift pin for ascending the wafer, when a dry cleaning period is reached.

In the etching chamber, as shown in FIG. 3, the electrostatic chuck cathode part 123 keeps sealing up the bottom face opening part 117 of main body 111 of the upper chamber 110 at an uppermost position thereof, while an etching is performed in the internal space of the upper chamber 110. A wafer is fixed onto an upper surface of the electrostatic chuck cathode part 123.

When the etching process on the wafer is completed, the cathode driving part 125 descends vertically, and then the electrostatic chuck cathode part 123 also descends. At this time, the electrostatic chuck cathode part 123 descends to a level of a wafer apply/discharge opening between the lower chamber 120 and a transfer chamber so as to transfer the wafer.

When the descent of the electrostatic chuck cathode part 123 is completed, the lift pin driving part 129 vertically ascends, and a lift pin contact part 129a of the lift pin driving part 129 vertically raises the lift pin 128. Thus, the wafer is spaced with a constant distance from an upper surface of the electrostatic chuck cathode part 123 by using the lift pin 128.

Subsequently, a door of the wafer apply/discharge opening is opened and a wafer transfer robot of the transfer chamber transfers the wafer to the transfer chamber through the wafer apply/discharge opening, and then the wafer is finally transferred to a wafer cassette.

Then, the robot puts another wafer for an etching process on the lift pin 128 of the electrostatic chuck cathode part 123, through the wafer apply/discharge opening from the wafer cassette, and goes back to an original position. Next, the door of wafer apply/discharge opening is closed. Subsequently, the lift pin contact part 129a descends by a drive operation of the lift pin driving part 129, and the lift pin 128 also descends. Thus, the wafer is fixed to an upper surface of the electrostatic chuck cathode part 123.

Then, the cathode driving part 125 ascends vertically to an uppermost position as available, thereby sealing up the bottom face opening part 117 of main body 111 of the upper chamber 110. In this state, an etching process is performed.

FIG. 4 is a flowchart for a lift drive control in a dry cleaning according to an exemplary embodiment of the invention.

Referring to FIGS. 3 and 4, a dry cleaning operation performed by driving only the electrostatic chuck cathode part 123 is described in detail, as follows.

First, in step 201, the controller 130 checks whether or not it is a cleaning period, and when it is the cleaning period, step 202 is performed. In step 202 the controller 130 checks whether a wafer completed for a process has been returned from an electrostatic chuck, and when returned, step 203 is performed. In step 203, the controller 130 drives the cathode driving part 125 and so raises the electrostatic chuck cathode part 123, and then step 204 is performed. In step 204, a cleaning gas is supplied to the upper chamber 110, forming plasma and thereby performing a cleaning process. Next, step 205 is executed. It is checked in step 205 whether a dry cleaning process is completed, and when the dry cleaning process is completed, step 206 is then performed. In step 206, the cathode driving part 125 is driven so that the electrostatic chuck cathode part 123 descends, and step 207 is then performed. In step 207 the electrostatic chuck cathode is placed into an idle state to perform a process.

As described above, according to some exemplary embodiments of the invention, only an electrostatic chuck cathode part ascends, by skipping, that is, not raising and lowering a lift pin to raise and lower a wafer in a dry cleaning process. Subsequently, the dry cleaning process is performed, thereby prolonging the drive life of lift cylinder through the skipped ascent/descent of lift pin and thereby also reducing processing costs.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A dry cleaning method for use in a semiconductor manufacturing apparatus having a multi-lifter, comprising:
checking whether it is a dry cleaning period, and when it is determined to be a dry cleaning period then checking whether a wafer completed for a process has been returned from an electrostatic chuck to the outside of the semiconductor manufacturing apparatus;
raising an electrostatic chuck cathode part when the wafer has been returned from the electrostatic chuck to the outside of the semiconductor manufacturing apparatus; and
forming plasma after raising the electrostatic chuck cathode part, and performing a dry cleaning process.

2. The method of claim 1, further comprising checking whether the dry cleaning process is completed.

3. The method of claim 2, further comprising lowering the electrostatic chuck cathode part when the dry cleaning process is completed.

4. The method of claim 3, further comprising placing the electrostatic chuck cathode into an idle state to perform a process after the electrostatic chuck cathode part is lowered.

5. A dry cleaning method for use in a semiconductor manufacturing apparatus having a multi-lifter, the method comprising;
checking whether it is a dry cleaning period, and when it is determined to be a dry cleaning period then checking whether a wafer completed for a process has been returned from an electrostatic chuck to the outside of the semiconductor manufacturing apparatus;
when the wafer has been returned from the electrostatic chuck to the outside of the semiconductor manufacturing apparatus, raising an electrostatic chuck cathode part without raising a lift pin of the multi-lifter for raising and lowering a wafer; and
forming plasma after raising the electrostatic chuck cathode part, and performing a dry cleaning process.

6. The method of claim 5, further comprising checking whether the dry cleaning process is completed.

7. The method of claim 6, further comprising: when the dry cleaning process is completed, lowering the electrostatic chuck cathode part without lowering the lift pin of the multi-lifter for raising and lowering a wafer.

8. The method of claim 7, further comprising placing the electrostatic chuck cathode into an idle state to perform a process after the electrostatic chuck cathode part is lowered.
